(19) United States
(12) Patent Application Publication
(10) Pub. No.: US 2022/0222555 A1
(43) Pub. Date: Jul. 14, 2022

(54) PARAMETER ESTIMATION APPARATUS, CONGESTION ESTIMATION APPARATUS, PARAMETER ESTIMATION METHOD, CONGESTION ESTIMATION METHOD AND PROGRAM

(71) Applicant: NIPPON TELEGRAPH AND TELEPHONE CORPORATION, Tokyo (JP)

(72) Inventors: Hitoshi SHIMIZU, Musashino-shi, Tokyo (JP); Tatsushi MATSUBAYASHI, Musashino-shi, Tokyo (JP); Akinori FUJINO, Musashino-shi, Tokyo (JP); Hiroshi SAWADA, Musashino-shi, Tokyo (JP)

(21) Appl. No.: 17/610,219

(22) PCT Filed: May 21, 2019
(86) PCT No.: PCT/JP2019/020176

§ 371 Date: Nov. 10, 2021

(51) Int. Cl. G06N 7/00; G06Q 10/04; G06K 9/62

(52) U.S. Cl. CPC G06N 7/005; G06K 9/6277; G06Q 10/04

(57) ABSTRACT

Assuming that a total number of N selection subjects n (n=1, . . . , N) each select any one of a total number of M selection targets m (m=1, . . . , M), parameter estimation means: inputs acceptable limits α_{n,m} of each selection subject n and calculates patience φₙ and a preference vector ψₙ, the acceptable limits α_{n,m} indicating limits of congestion degrees of respective selection subjects m that are acceptable to the selection subject n, the patience φₙ indicating the largest value of the acceptable limits α_{n,m} of the selection subject n with respect to the selection targets m, the preference vector ψₙ indicating preference of the selection subject n when selecting the selection targets m; and estimates parameters of a model for obtaining acceptable limits α_{i,m} of each of a total number of I(>N) selection subjects i (i=1, . . . , I) by using the calculated patience φₙ and the calculated preference vector ψₙ.

### TECHNICAL FIELD

The present invention relates to a parameter estimation device, a congestion degree estimation device, a parameter estimation method, a congestion degree estimation method, and a program.

### BACKGROUND ART

Problems called theme park problems are conventionally known. Theme park problems are problems for analyzing selection of attractions by visitors, estimating congestion conditions, and considering and evaluating control strategies for reducing congestion, for example, by reproducing congestion conditions of a theme park through multi-agent simulation (MAS). Various conventional technologies have been proposed for such theme park problems.

For example, PTL 1 describes a technology for predicting a waiting time of an attraction in a theme park. Also, PTL 2 describes a technology for finding an optimum control strategy for reducing congestion in a theme park or the like.

### CITATION LIST

### Patent Literature

[PTL 1] Japanese Patent Application Publication No. 2018-073361
[PTL 2] Japanese Patent Application Publication No. 2018-147087

### SUMMARY OF THE INVENTION

### Technical Problem

Incidentally, when visitors select attractions in a theme park, commonly, there are individual differences in preference between the visitors. That is, visitors commonly select attractions according to their own preference. However, individual differences in preference between visitors are not taken into consideration in the conventional technologies. Therefore, when congestion degrees such as waiting times of attractions are estimated, the accuracy of estimation may be not high.

An embodiment of the present invention was made in view of the foregoing, and has an object of estimating congestion degrees with high accuracy.

### Means for Solving the Problem

In order to achieve the object described above, a parameter estimation device according to an embodiment of the present invention includes parameter estimation means for, assuming that a total number of N selection subjects n (n=1, . . . , N) each select any one of a total number of M selection targets m (m=1, . . . , M), inputting acceptable limits α_{n,m} of each selection subject n and calculating patience φₙ and a preference vector ψₙ, the acceptable limits α_{n,m} indicating limits of congestion degrees of respective selection subjects m that are acceptable to the selection subject n, the patience φₙ indicating the largest value of the acceptable limits α_{n,m} of the selection subject n with respect to the selection targets m, the preference vector ψₙ indicating preference of the selection subject n when selecting the selection targets m, and estimating parameters of a model for obtaining acceptable limits α_{i,m} of each of a total number of I(>N) selection subjects i (i=1, . . . , I) by using the calculated patience φₙ and the calculated preference vector ψₙ.

Also, a congestion degree estimation device according to an embodiment of the present invention includes: parameter estimation means for, assuming that a total number of N selection subjects n (n=1, . . . , N) each select any one of a total number of M selection targets m (m=1, . . . , M), inputting acceptable limits α_{n,m} of each selection subject n and calculating patience φₙ and a preference vector ψₙ, the acceptable limits α_{n,m} indicating limits of congestion degrees of respective selection subjects m that are acceptable to the selection subject n, the patience φₙ indicating the largest value of the acceptable limits α_{n,m} of the selection subject n with respect to the selection targets m, the preference vector ψₙ indicating preference of the selection subject n when selecting the selection targets m, and for estimating parameters of a model for obtaining acceptable limits α_{i,m} of each of a total number of I(>N) selection subjects i (i=1, . . . , I) by using the calculated patience φₙ and the calculated preference vector ψₙ; calculation means for calculating the acceptable limits α_{i,m} of each selection subject i by using the model in which the estimated parameters are used; and congestion degree estimation means for estimating congestion degrees of the respective selection targets m at each time point t (t=1, . . . , T) by inputting the acceptable limits α_{i,m} and simulation conditions and simulating selection of the selection targets m by the selection subjects i at each time point t.

### Effects of the Invention

Congestion degrees can be estimated with high accuracy.

### BRIEF DESCRIPTION OF DRAWINGS

FIG. 1 is a diagram showing an example of the entire configuration of a congestion degree estimation device according to an embodiment of the present invention.

FIG. 2 is a flowchart showing an example of processing for estimating parameters of an acceptable limit model.

FIG. 3 is a diagram showing an example of acceptable limit data for parameter estimation.

FIG. 4 is a diagram showing an example of patience φₙ and attraction preferences ψ_{n,m}.

FIG. 5 is a flowchart showing an example of processing for creating visitor data for simulation.

FIG. 6 is a diagram showing an example of creation of an acceptable limit vector αᵢ.

FIG. 7 is a diagram showing an example of visitor data for simulation.

FIG. 8 is a diagram showing an example of setting of an arrival time Iᵢ and a leave time Oᵢ.

FIG. 9 is a diagram showing an example of setting of a planned number kᵢ.

FIG. 10 is a diagram showing an example of arrangement of attractions.

FIG. 11 is a diagram showing an example of movement time data for simulation.

FIG. 12 is a diagram showing an example of attraction data for simulation.

FIG. 13 is a diagram showing an example of state transition of visitors.

FIG. 14 is a flowchart showing an example of processing for estimating congestion degrees through simulation.

FIG. 15 is a diagram showing an example of simulation results.

FIG. 16 is a diagram showing an example of a hardware configuration of the congestion degree estimation device according to an embodiment of the present invention.

### DESCRIPTION OF EMBODIMENTS

The following describes an embodiment of the present invention. In the embodiment of the present invention, a congestion degree estimation device 10 that estimates congestion degrees of respective attractions (e.g., waiting times of respective attractions) of a theme park in which a plurality of attractions are arranged will be described, the congestion degree estimation device 10 estimating the congestion degrees through simulation, taking preference of each visitor for an attraction into consideration. Here, the term “theme park” refers to a tourist facility of which a part or the entirety is produced based on a theme, and specific examples of theme parks include amusement parks and the like. Note that a theme park may also be called a leisure land or the like.

However, estimation of congestion degrees of attractions in a theme park through simulation is an example, and the embodiment of the present invention can be similarly applied to estimation of congestion degrees of respective targets through simulation in a case where a plurality of targets (e.g., attractions) that can be selected by selection subjects (e.g., visitors) are arranged. For example, the embodiment can be similarly applied to estimation of congestion degrees of respective event booths through simulation in an event site in which a plurality of event booths that can be selected by visitors are arranged.

<Theoretical Configuration>

The following describes a theoretical configuration of the embodiment of the present invention.

<<Estimation of Parameters of Acceptable Limit Model>>

Let M be the number of attractions, and m (m=1, . . . , M) be an index of each attraction, and an attraction that has an index m will be referred to as an “attraction m”. Similarly, let n be an index of each visitor, and a visitor who has an index n will be referred to as a “visitor n”. Also, let α_{n,m} be an acceptable limit of waiting time of the visitor n for the attraction m (i.e., a scalar value that indicates a waiting time that the visitor n can accept for the attraction m).

In the embodiment of the present invention, parameters of a model expressed by the following Expressions (1) and (2) (this model will also be referred to as an “acceptable limit model”) are estimated using acceptable limits α_{n,m} (n=1, . . . , N, m=1, . . . , M) that are acquired in advance from N visitors using questionnaires or the like, for example.

$$\begin{matrix}[ Math . 1 ] & \\ {ϕ}_{n} = {max}_{m} {α}_{n , m} & ( 1 ) \\ {ψ}_{n} = \frac{{α}_{n}}{{\sum }_{m} {α}_{n , m}} & ( 2 )\end{matrix}$$

Here, φₙ represents the largest value of acceptable limits of waiting time of the visitor n, and will also be referred to as “patience” in the following description. αₙ is an M-dimensional vector that includes an acceptable limit α_{n,m} (m=1, . . . , M) of the visitor n as the m-th element, and will also be referred to as an “acceptable limit vector” in the following description. ψₙ is an M-dimensional vector that includes a scalar value ψ_{n,m} that indicates relative preference of the visitor n for the attraction m as the m-th element. In the following description, ψ_{n,m} will also be referred to as an “attraction preference”, and ψₙ will also be referred to as an “attraction preference vector”.

In the embodiment of the present invention, parameters μ and σ² are estimated using a maximum likelihood method or the like, assuming that the patience φₙ follows a log-normal distribution, i.e., log(φₙ)˜N(μ,σ²). Note that μ and σ² are mean and variance of a normal distribution, respectively.

Also, in the embodiment of the present invention, a parameter β is estimated using a maximum likelihood method, assuming that the attraction preference vector ψₙ follows a Dirichlet distribution Dir(β), i.e., ψₙ˜Dir(β). Note that β is a parameter of the Dirichlet distribution and is expressed as an M-dimensional vector (β₁, . . . , β_{M}).

<<Creation of Visitor Data for Simulation>>

Let I be the number of visitors used to simulate congestion degrees of attractions, and i be an index of each visitor, and a visitor who has an index i will be referred to as a “visitor i”. Note that the number I of visitors used for the simulation is very large when compared to the number N of visitors used to estimate the parameters of the acceptable limit model.

In the embodiment of the present invention, patience φᵢ (i=1, . . . , I) and attraction preference vectors ψᵢ (i=1, . . . , I) are generated using the parameters μ, σ², and β estimated as described above, and then acceptable limit vectors αᵢ (i=1, . . . , I) are generated using the following Expression (3).

$$\begin{matrix}[ Math . 2 ] & \\ {α}_{i} = {ϕ}_{i} \times \frac{{ψ}_{i}}{max {ψ}_{i}} & ( 3 )\end{matrix}$$

Then, visitor data for simulation is created using the acceptable limit vectors αᵢ. Note that the visitor data for simulation includes acceptable limits α_{i,m} of a visitor i for respective attractions m, an arrival time Iᵢ and a leave time Oᵢ of the visitor i, and a planned number kᵢ of attractions that the visitor i will experience (i.e., a number that indicates how many attractions the visitor i plans to experience).

<<Simulation>>

Waiting times (an example of congestion degrees) of respective attractions m at each simulation time point t are estimated using the visitor data for simulation, attraction data for simulation, and movement time data for simulation. Note that the attraction data for simulation is data that indicates a processing capacity of each attraction (i.e., the number of people who can experience the attraction in a unit time) in simulation, for example. Also, the movement time data for simulation is data that indicates the time it takes to move between attractions (and the time it takes to move between the entrance of the theme park and an attraction) in simulation, for example.

In the embodiment of the present invention, a probability θ_{i,m,t} of a visitor i selecting an attraction m at a simulation time point t is calculated using a model expressed by the following Expression (4) (this model will also be referred to as a “polynomial linear model”).

$$\begin{matrix}[ Math . 3 ] & \\ {θ}_{i , m , t} = \{ \begin{matrix}\frac{{A}_{i , m , t}}{{\sum }_{m} {A}_{i , m , t}} & {\sum }_{m} {A}_{i , m , t} > 0 \\ 0 & {\sum }_{m} {A}_{i , m , t} = 0\end{matrix} & ( 4 )\end{matrix}$$

Here, A_{i,m,t}=max(0, α_{i,m}-W_{m,t}), and W_{m,t} represents a waiting time of the attraction m at the time point t. Note that α_{i,m} is the m-th element of the acceptable limit vector αᵢ (i.e., an acceptable limit of the visitor i for the attraction m).

Thus, waiting times (an example of congestion degrees) of respective attractions m for which attraction preferences ψ_{i,m} of each visitor i are taken into consideration are estimated as simulation results.

Note that the polynomial linear model expressed by the above Expression (4) is a model that is obtained by extending a conventionally known linear model non-negatively such that conditions of logical consistency are satisfied. The conditions of logical consistency are constraint conditions that, when an option is selected from a finite number of options, the sum of selection probabilities of all options is 1 and the selection probabilities of all options are not negative, under the condition that any one of the options is always selected.

<Entire Configuration of Congestion Degree Estimation Device 10>

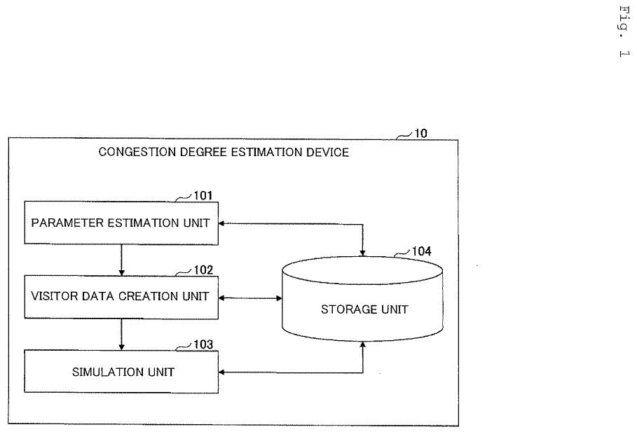

Next, the entire configuration of the congestion degree estimation device 10 according to the embodiment of the present invention will be described with reference to FIG. 1. FIG. 1 is a diagram showing an example of the entire configuration of the congestion degree estimation device 10 according to the embodiment of the present invention.

As shown in FIG. 1, the congestion degree estimation device 10 according to the embodiment of the present invention includes a parameter estimation unit 101, a visitor data creation unit 102, a simulation unit 103, and a storage unit 104. Note that the parameter estimation unit 101, the visitor data creation unit 102, and the simulation unit 103 are realized through processing that one or more programs installed in the congestion degree estimation device 10 cause a processor or the like to execute, for example. Also, the storage unit 104 can be realized using a suitable storage device such as an auxiliary storage device of the congestion degree estimation device 10 or a recording medium, for example.

Various types of data are stored in the storage unit 104. Examples of data stored in the storage unit 104 include acceptable limit data for parameter estimation, which will be described later, the parameters μ, σ², and β of the acceptable limit model, the visitor data for simulation, the attraction data for simulation, the movement time data for simulation, and the number I of visitors used for simulation. Also, waiting times W_{m,t} of respective attractions m at a simulation time point t are stored in the storage unit 104.

The parameter estimation unit 101 estimates the parameters μ, σ², and β of the acceptable limit model expressed by the above Expressions (1) and (2), taking the acceptable limit data for parameter estimation as an input. Here, the acceptable limit data for parameter estimation is data that indicates acceptable limits α_{n,m} (n=1, . . . , N, m=1, . . . , M) that are acquired in advance from N visitors using questionnaires or the like, for example.

The visitor data creation unit 102 generates acceptable limit vectors αᵢ (i=1, . . . , I), taking the parameters μ, σ², and β estimated by the parameter estimation unit 101 and the number I of visitors used for simulation as inputs. Then, the visitor data creation unit 102 creates visitor data for simulation using the acceptable limit vectors αᵢ (i=1, . . . , I).

The simulation unit 103 estimates waiting times W_{m,t} of respective attractions m at each simulation time point t, taking the visitor data for simulation, the attraction data for simulation, and the movement time data for simulation as inputs. In the embodiment of the present invention, a simulation time point t is expressed as a non-negative integer value of which unit is “minutes”, and indicates a time [minutes] passed from the start of simulation. Specifically, a simulation end time point is represented by T [minutes], and each simulation time point t is expressed as t=0, 1, 2, . . . , T [minutes]. However, there is no limitation to this example, and the simulation time point t may represent an index of a suitable unit period (e.g., 30 minutes or 1 hour).

Note that the entire configuration of the congestion degree estimation device 10 shown in FIG. 1 is an example, and another configuration is also possible. For example, the parameter estimation unit 101, the visitor data creation unit 102, and the simulation unit 103 may be included in difference devices. That is, the congestion degree estimation device 10 shown in FIG. 1 may be divided into a parameter estimation device that includes the parameter estimation unit 101, a visitor data creation device that includes the visitor data creation unit 102, and a simulation device that includes the simulation unit 103, for example.

<Processing for Estimating Parameters of Acceptable Limit Model>

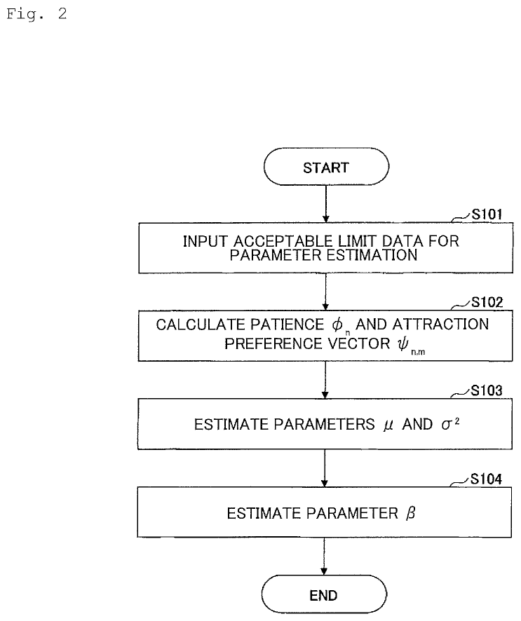

The following describes processing for estimating the parameters of the acceptable limit model with reference to FIG. 2. FIG. 2 is a flowchart showing an example of the processing for estimating the parameters of the acceptable limit mode.

Step S101: The parameter estimation unit 101 inputs acceptable limit data for parameter estimation. As described above, the acceptable limit data for parameter estimation is data that indicates acceptable limits α_{n,m} (n=1, . . . , N, m=1, . . . , M, e.g., data that is expressed with a N×M matrix in which a (n,m)-component is α_{n,m}). Note that the parameter estimation unit 101 may input acceptable limit data for parameter estimation that is stored in the storage unit 104 or acceptable limit data for parameter estimation that is transmitted from another device connected via a communication network, for example.

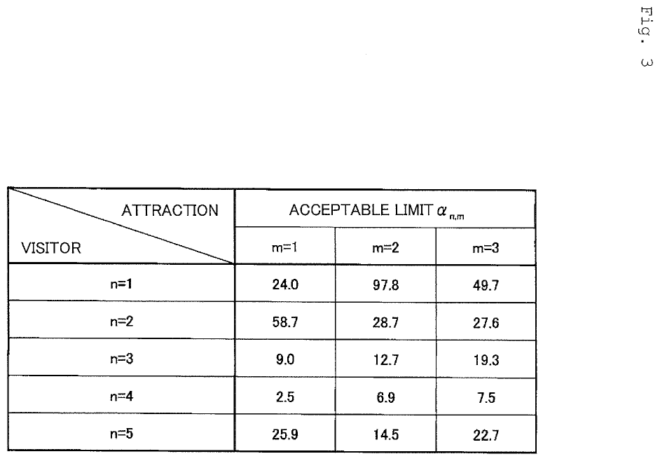

Here, FIG. 3 shows a specific example of the acceptable limit data for parameter estimation in a case where N=5 and M=3. In the case shown in FIG. 3, acceptable limit α_{1,1}=24.0, acceptable limit α_{1,2}=97.8, and acceptable limit α_{1,3}=49.7. Similarly, acceptable limit α_{2,1}=58.7, acceptable limit α_{2,2}=28.7, and acceptable limit α_{2,3}=27.6. Acceptable limits of n=3, 4, 5 are as shown in FIG. 3.

Step S102: The parameter estimation unit 101 calculates patience φₙ based on the above Expression (1) and calculates an attraction preference vector ψₙ based on the above Expression (2) by using acceptable limits α_{n,m} (n=1, . . . , N, m=1, . . . , M) indicated by the acceptable limit data for parameter estimation. That is, with respect to each visitor n, the parameter estimation unit 101 takes the largest value of acceptable limits α_{n,m} of waiting time for respective attractions m to be the patience en. Also, with respect to each visitor n, the parameter estimation unit 101 takes a ratio of an acceptable limit α_{n,m} of waiting time for an attraction m relative to all attractions to be an attraction preference ψ_{n,m}. Note that the attraction preference ψ_{n,m} is no smaller than 0 and no greater than 1, and the closer the value of the attraction preference is to 1, the more preferentially the corresponding attraction is selected.

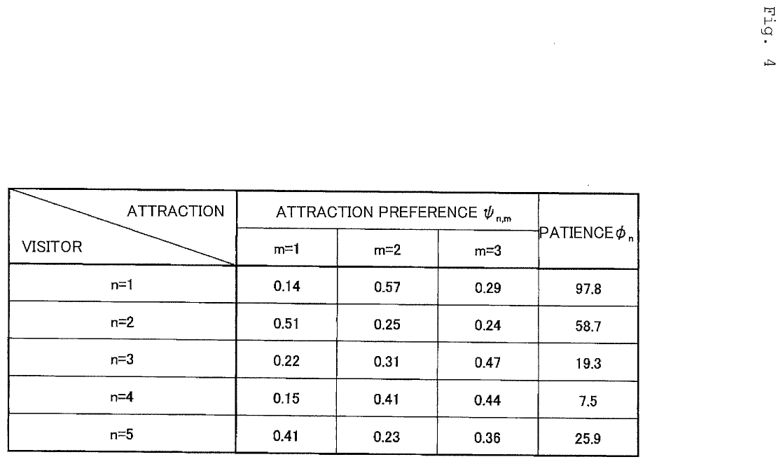

Here, FIG. 4 shows a specific example of patience φₙ and attraction preferences ψ_{n,m}, which are elements of the attraction preference vector ψₙ, in a case where N=5 and M=3. In the case shown in FIG. 4, attraction preference ψ_{1,1}=0.14, attraction preference ψ_{1,2}=0.57, and attraction preference ψ_{1,3}=0.29. Similarly, attraction preference ψ_{2,1}=0.51, attraction preference ψ_{2,2}=0.25, and attraction preference ψ_{2,3}=0.24. Attraction preferences of n=3, 4, 5 are as shown in FIG. 4.

Also, in the case shown in FIG. 4, patience ρ₁=97.8, patience φ₂=58.7, patience φ₃=19.3, patience φ₄=7.5, and patience φ₅=25.9.

Step S103: The parameter estimation unit 101 estimates the parameters μ and σ² using a maximum likelihood method, assuming that the patience φₙ (n=1, . . . , N) calculated in step S102 described above follows a log-normal distribution (i.e., log(φₙ)˜N(μ,σ²)). This estimation can be performed using a method described in ‘C. M. Bishop, “Pattern Recognition and Machine Learning (Vol. 1) Statistical Prediction Using Bayesian Approach”, p. 24 (1.2.4 Gaussian distribution)’, for example.

Step S104: The parameter estimation unit 101 estimates the parameter β using a maximum likelihood method, assuming that the attraction preference vector ψₙ calculated in step S102 described above follows a Dirichlet distribution Dir(β) (i.e., ψₙ˜Dir((β)). This estimation can be performed using a method described in ‘Thomas P. Minka, “Estimating a Dirichlet distribution”, <URL:https://tminka.github.io/papers/dirichlet/minka-dirichlet .pdf>’, for example. Note that the parameter β is an M-dimensional vector expressed as β=(β₁, . . . , β_{M}), as described above.

Through the above, the parameters μ, σ², and β of the acceptable limit model are estimated. These parameters μ, σ², and are stored in the storage unit 104 by the parameter estimation unit 101, for example.

<Processing for Creating Visitor Data for Simulation>

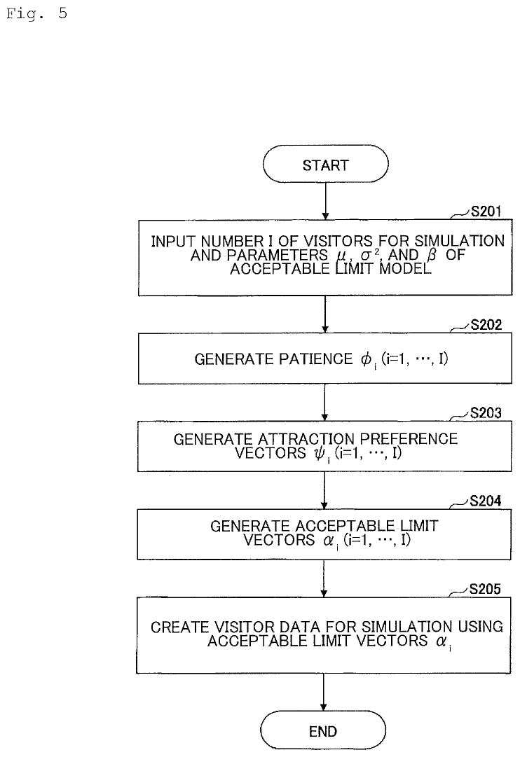

The following describes processing for creating visitor data for simulation with reference to FIG. 5. FIG. 5 is a flowchart showing an example of the processing for creating visitor data for simulation.

Step S201: The visitor data creation unit 102 inputs the number I of visitors used for simulation and the parameters μ, σ², and β of the acceptable limit model. These parameters μ, σ², and β are the parameters estimated by the parameter estimation unit 101. Note that the visitor data creation unit 102 may input the parameters μ, σ², and β stored in the storage unit 104 or the parameters μ, σ², and β transmitted from another device connected via a communication network, for example. Also, the visitor data creation unit 102 may input the number I of visitors stored in the storage unit 104, the number I of visitors transmitted from another device connected via a communication network, or the number I of visitors specified through an input device such as a keyboard, for example.

Step S202: The visitor data creation unit 102 generates random numbers rᵢ (i=1, . . . , I) that follow a normal distribution N(μ, σ²), and then generates patience φᵢ (i=1, . . . , I) from the random numbers rᵢ (i=1, . . . , I). That is, the visitor data creation unit 102 generates patience φᵢ for each i=1, . . . , I, using the following expression: φᵢ=e^{ri}. Note that e represents the Napier's constant.

Step S203: The visitor data creation unit 102 generates I M-dimensional vectors that follow the Dirichlet distribution Dir(β) at random, and take these M-dimensional vectors to be attraction preference vectors ψᵢ (i=1, . . . , I).

Step S204: The visitor data creation unit 102 generates acceptable limit vectors αᵢ (i=1, . . . , I) based on the above Expression (3) by using the patience φᵢ and the attraction preference vectors ψᵢ. As shown in the above Expression (3), with respect to i=1, . . . , I, the visitor data creation unit 102 normalizes attraction preferences ψ_{i,m} (m=1, . . . , M) such that the largest value of the attraction preferences ψ_{i,m} becomes 1, and then generates an acceptable limit vector αᵢ such that an acceptable limit α_{i,m} is a product of a normalized ψ_{i,m} and the patience φᵢ.

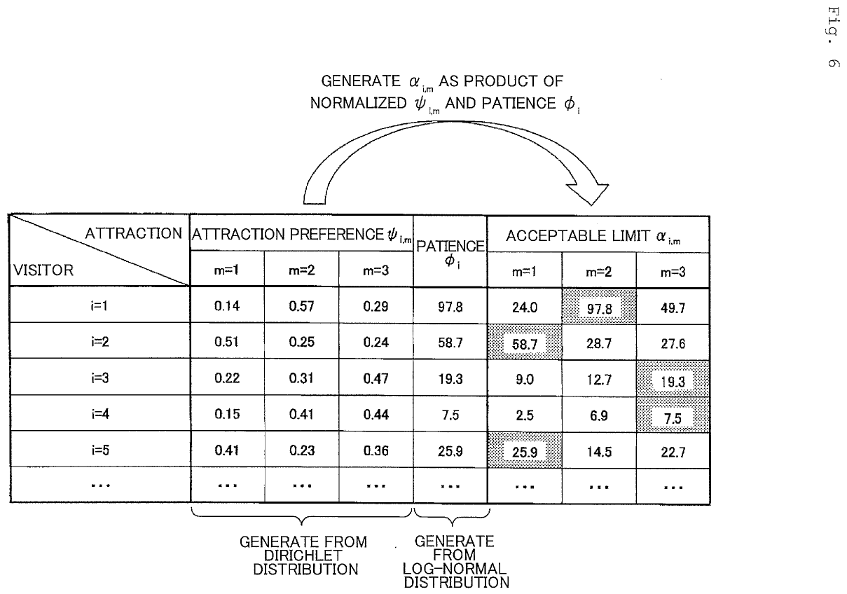

Here, FIG. 6 shows a specific example of generation of the acceptable limit vector αᵢ in a case where M=3. In FIG. 6, in the case of i=1, maxψ₁=0.57 and φ₁=97.8. Therefore, acceptable limits α_{1,1}, α_{1,2}, and α_{1,3}, which are elements of an acceptable limit vector α₁, are as follows: α_{1,1}=97.8×(0.14/0.57)=24.0, α_{1,2}=97.8×(0.57/0.57)=97.8, and α_{1,3}=97.8×(0.29/0.57)=49.7.

Similarly, in FIG. 6, in the case of i=2, maxψ₂=0.51 and φ₂=58.7. Therefore, acceptable limits α_{2,1}, α_{2,2}, and α_{2,3}, which are elements of an acceptable limit vector α₂, are as follows: α_{2,1}=58.7×(0.51/0.51)=58.7, α_{2,2}=58.7×(0.25/0.51)=28.7, and α_{2,3}=58.7×(0.24/0.51)=27.6. With respect to i=3 and the following values of i as well, elements α_{i,1}, α_{i,2}, and α_{i,3} of an acceptable limit vector αᵢ are calculated in a similar manner.

Step S205: The visitor data creation unit 102 creates visitor data for simulation using the acceptable limit vectors αᵢ (i=1, . . . , I). As described above, the visitor data for simulation includes acceptable limits α_{i,m} of a visitor i for respective attractions m, an arrival time Iᵢ and a leave time Oᵢ of the visitor i, and a planned number kᵢ of attractions that the visitor i will experience. Note that a pair of the arrival time Iᵢ and the leave time Oᵢ may also be referred to as a “stay time”.

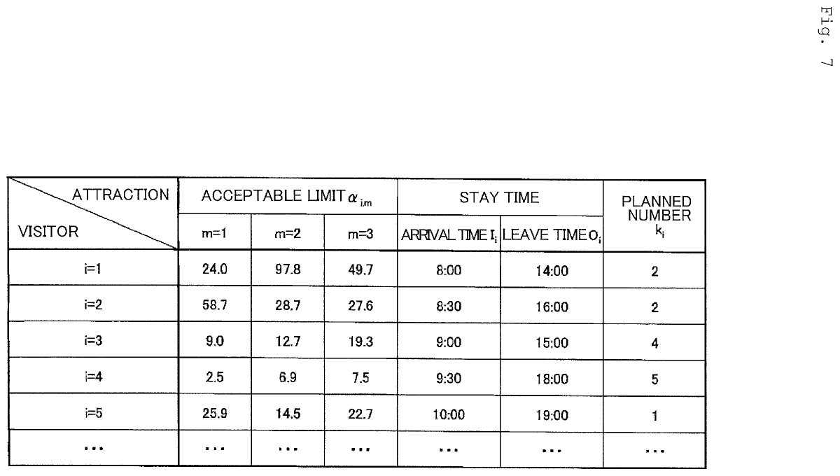

Here, FIG. 7 shows visitor data for simulation in a case where M=3. In FIG. 7, in the case of i=1, acceptable limit α_{1,1}=24.0, acceptable limit α_{1,2}=97.8, acceptable limit α_{1,3}=49.7, arrival time I₁=8:00, leave time O₁=14:00, and planned number k₁=2. Similarly, in the case of i=2, acceptable limit α_{2,1}=58.7, acceptable limit α_{2,2}=28.7, acceptable limit α_{2,3}=27.6, arrival time I₂=8:30, leave time O₂=16:00, and planned number k₂=2. Data regarding i=3 and the following values of i is as shown in FIG. 7.

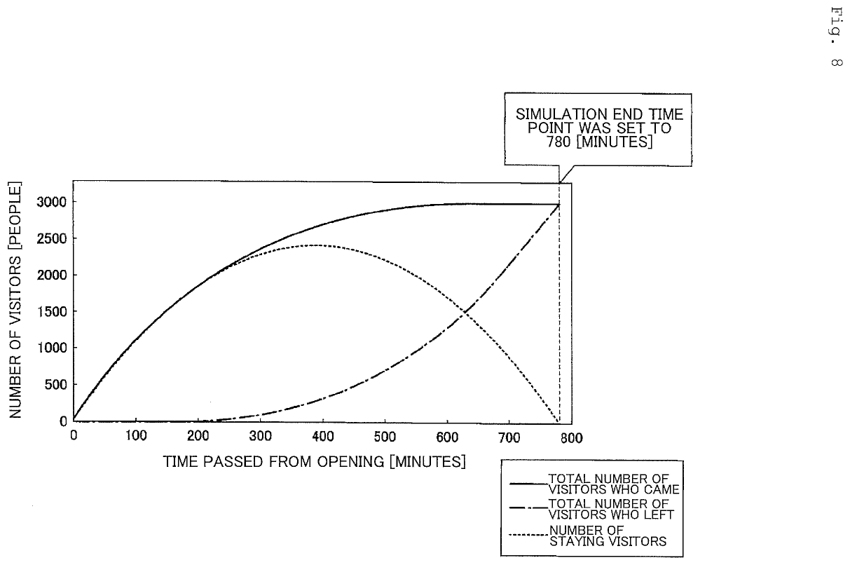

Although an arrival time Iᵢ and a leave time Oᵢ of a visitor i can be set to suitable time points, it is commonly thought that a peak of the number of visitors staying in an actual theme park often appears in the daytime. Therefore, in the embodiment of the present invention, the arrival time Iᵢ and the leave time Oᵢ of each visitor i are set such that a peak of the number of visitors i staying in the theme park appears in the daytime. Specifically, assuming that the opening time of the theme park is “8:00”, the closing time of the theme park is “21:00”, and a total of 3,000 people visit the theme park per day, the arrival time Iᵢ and the leave time Oᵢ of each visitor i are set such that a peak of the number of visitors staying in the theme park appears between t=300 and t=400 as shown in FIG. 8, where the simulation time point t is from 0 [minutes] to T=780 [minutes], and I=3000. Note that T represents the simulation end time point, as described above.

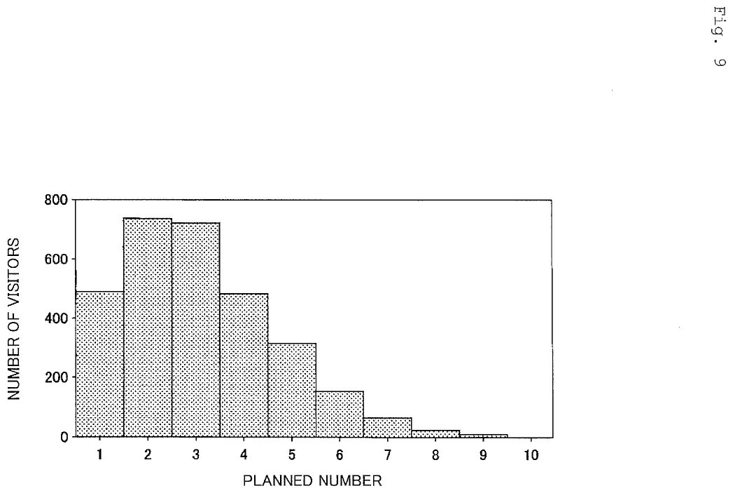

Also, although planned numbers kᵢ of respective visitors i can be set to suitable integer values, in the embodiment of the present invention, the planned numbers kᵢ are set so as to follow a Poisson distribution of which mean is 3 (however, 0 is excluded). FIG. 9 shows a histogram of the planned numbers kᵢ (i=1, . . . , 3000) in a case where I=3000.

Through the above, visitor data for simulation is created. The visitor data is stored in the storage unit 104 by the visitor data creation unit 102, for example.

<Simulation Conditions>

Before describing processing for estimating congestion degrees through simulation, various conditions of the simulation will be described as presuppositions.

<<Movement Time>>

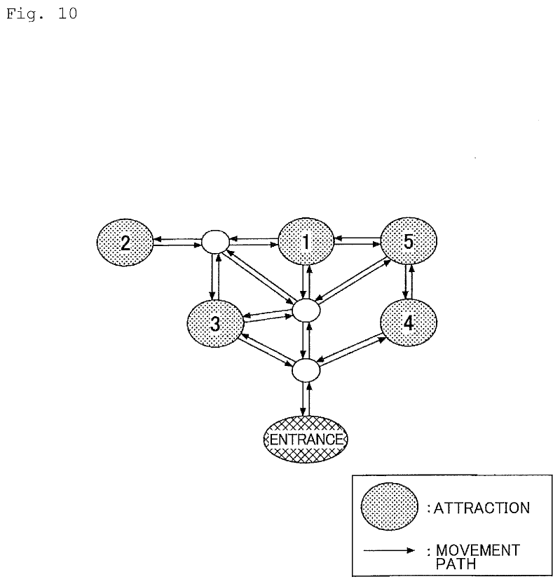

The time it takes for each visitor i to move between attractions and the time it takes for each visitor i to move between the entrance of the theme park and an attraction in simulation are given from movement time data for simulation. In the embodiment of the present invention, it is assumed that M=5 and arrangement of the attractions m and movement paths between the attractions and the entrance are as shown in FIG. 10. Note that each figure shown in a circle that represents an attraction in FIG. 10 is the index of the attraction.

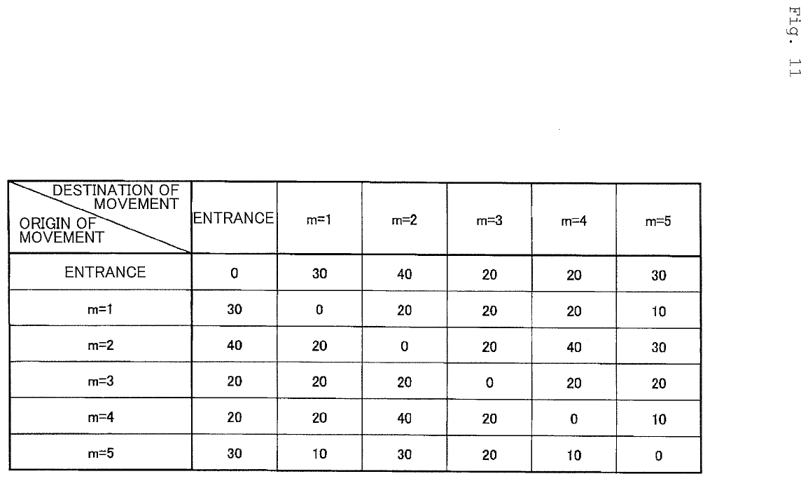

Assume that movement time data for simulation shown in FIG. 11 is given. In the movement time data for simulation shown in FIG. 11, movement times from origins to destinations of movement are expressed in the form of a matrix. For example, if the origin of movement is the “entrance” and the destination of movement is the “attraction m=l”, the movement time is 30 [minutes]. Similarly, if the origin of movement is the “attraction m=1” and the destination of movement is the “attraction m=5”, the movement time is 10 [minutes].

<<Processing Capacity of Attraction>>

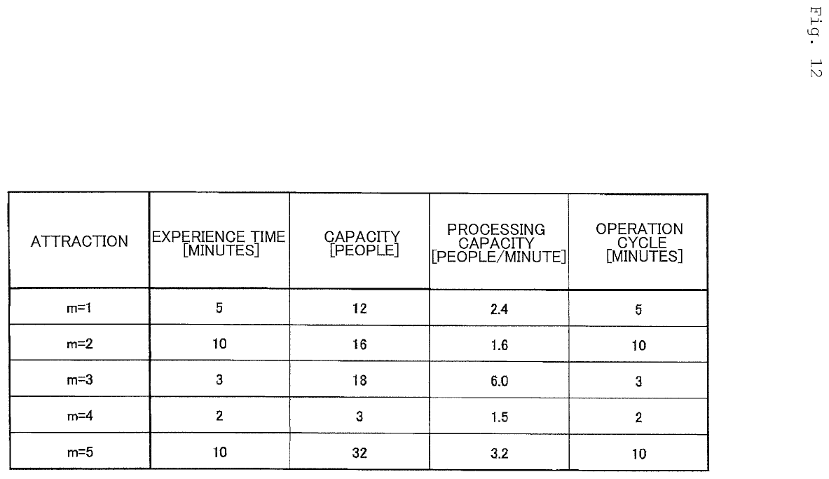

A processing capacity of each attraction (i.e., the number of people who can experience the attraction in a unit time) in simulation is given from attraction data for simulation. In the embodiment of the present invention, it is assumed that M=5 and attraction data for simulation shown in FIG. 12 is given. In the attraction data for simulation shown in FIG. 12, experience times [minutes] of respective attractions, capacities [people] of respective attractions, processing capacities [people/minute] of respective attractions, and operation cycles [minutes] of respective attractions are expressed in the form of a matrix. Note that a processing capacity is equal to “capacity/experience time”.

For example, in the case of the attraction m=1, the experience time is “5 minutes”, the capacity is “12 people”, the processing capacity is “2.4”, and the operation cycle is “5”. This means that the attraction m=1 operates every 5 minutes, 12 people can experience the attraction m=1 at the same time in a single operation, and the time it takes to experience the attraction m=1 once is 5 minutes.

Note that the attraction data for simulation in the embodiment of the present invention includes the “processing capacity”, but there is no limitation thereto, and attraction data for simulation is only required to include at least “information with which the processing capacity can be specified”. The information with which the processing capacity can be specified may be a pair of the “capacity” and the “experience time” or the “processing capacity” itself.

<<State Transition and the Like of Visitors i>>

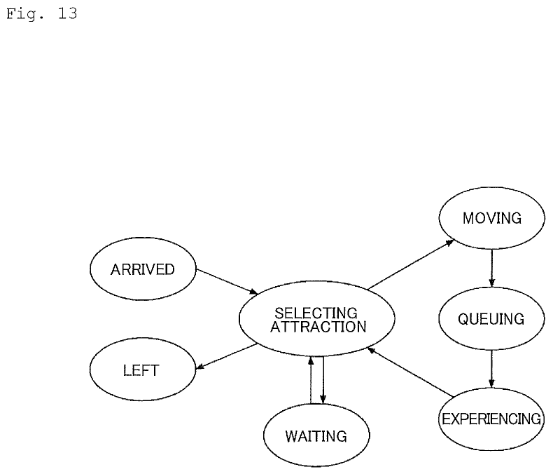

In simulation, any one of the states shown in FIG. 13 (“arrived”, “left”, “selecting attraction”, “moving”, “queuing”, “experiencing”, and “waiting”), a position in the theme park, and the like are associated with each visitor i. That is, for example, the index i of a visitor and the state, position, and the like of the visitor are stored in the storage unit 104 in association with each other. Assume that the state “arrived” and a position “entrance” are associated with each visitor i in an initial state.

The state, position, and the like of each visitor i are updated at each simulation time point t, following conditions described below in (C1) to (C9).

(C1) Visitor i in the state of “arrived” If the arrival time Iᵢ is before the simulation time point t, the state of the visitor i is updated to “selecting attraction”. This means that, upon the simulation time point t becoming the arrival time Iᵢ, the visitor i enters the theme park and starts to select an attraction.

(C2) Visitor i who has a planned number kᵢ≠0 and is in the state of “selecting attraction”

A selection probability θ_{i,m,t} of each attraction m is calculated using the polynomial linear model expressed by the above Expression (4), and an attraction m that the visitor i will experience next is selected based on the probability. Specifically, based on the selection probability θ_{i,m,t}, an attraction m is selected from candidate attractions m for which the following is satisfied: waiting time W_{m,t}<α_{i,m}.

If any one of the attractions m is selected, the state of the visitor i is updated to “moving”. At this time, a “movement completion time point” that is obtained by adding a movement time from the current position to the “selected attraction m” to the simulation time point t is associated with the visitor i, and the position of the visitor i is updated to the “selected attraction m”. The movement time is acquired from the movement time data for simulation described above. Note that in order to express individual differences in movement time between visitors i, it is also possible to perform addition, subtraction, multiplication, or division on the movement time acquired from the movement time data for simulation, by using a random number.

On the other hand, if none of the actions m is selected (i.e., for all attractions m, W_{m,t}≥α_{i,m} and θ_{i,m,t}=0), the state of the visitor i is updated to “waiting”. At this time, a “waiting end time point” that is obtained by adding a waiting time (e.g., “30 minutes”) determined in advance to the simulation time point t is associated with the visitor i. Note that the waiting time may be determined in advance, or a random number may be used as the waiting time.

(C3) Visitor i who has a planned number kᵢ=0 and is in the state of “selecting attraction”

The state of the visitor i is updated to “left”. Also, the position of the visitor i is updated to the “entrance”. This means that the visitor i has experienced the planned number of attractions and therefore leaves the theme park.

(C4) Visitor i in the state of “moving”

If the movement completion time point associated with the visitor i is before the simulation time point t, the state of the visitor i is updated to “queuing”. Also, an “experience start time point” that is obtained by adding the waiting time W_{m,t} of the attraction m that the visitor i will experience to the simulation time point t and an “experience end time point” that is obtained by adding the experience time of the attraction m to the experience start time point are associated with the visitor i. Note that the movement completion time point associated with the visitor i is deleted (or may also be updated to a time point after the closing time).

(C5) Visitor i in the state of “queuing”

If the experience start time point associated with the visitor i is before the simulation time point t, the state of the visitor i is updated to “experiencing”. Note that the experience start time point associated with the visitor i is deleted (or may also be updated to a time point after the closing time).

(C6) Visitor i in the state of “experiencing”

If the experience end time point associated with the visitor i is before the simulation time point t, the state of the visitor i is updated to “selecting attraction”. Also, 1 is subtracted from the planned number kᵢ of the visitor i.

(C8) Visitor i in the state of “waiting”

If the waiting end time point associated with the visitor i is before the simulation time point t, the state of the visitor i is updated to “selecting attraction”.

(C9) Visitors i in all states other than “arrived” and “left”

If the leave time Oᵢ is before the simulation time point t, the state of the visitor i is updated to “left”. Also, the position of the visitor i is updated to the “entrance”. This means that, upon the simulation time point t becoming the leave time Oᵢ, the visitor i leaves the theme park.

<Processing for Estimating Congestion Degree Through Simulation>

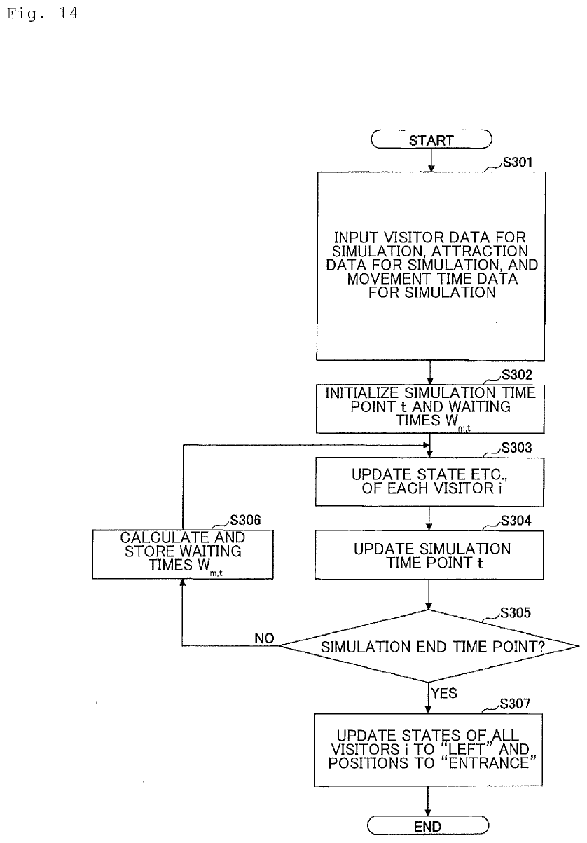

The following describes processing for estimating congestion degrees through simulation under the various conditions described above in “Simulation Conditions”, with reference to FIG. 14. FIG. 14 is a flowchart showing an example of the processing for estimating congestion degrees through simulation.

Step S301: The simulation unit 103 inputs visitor data for simulation, attraction data for simulation, and movement time data for simulation. Note that the simulation unit 103 may input these types of data stored in the storage unit 104 or these types of data transmitted from another device connected via a communication network, for example.

Step S302: The simulation unit 103 initializes the simulation time point t to a simulation start time point, and initializes waiting times W_{m,t} of respective attractions m to 0. Note that the simulation start time point can be set to t=0, but there is no limitation thereto, and the simulation start time point may be set to a suitable time point.

Step S303: The simulation unit 103 updates the state, position, and the like of each visitor i, following the conditions described above in (C1) to (C9).

Step S304: Next, the simulation unit 103 updates the simulation time point t. That is, the simulation unit 103 adds 1 to the simulation time point t.

Step S305: The simulation unit 103 determines whether or not the simulation time point t is the simulation end time point T. Upon determining that the simulation time point t is not the simulation end time point T, the simulation unit 103 proceeds to step S306. On the other hand, upon determining that the simulation time point t is the simulation end time point T, the simulation unit 103 proceeds to step S307.

Step S306: The simulation unit 103 calculate waiting times W_{m,t} of the respective attractions m, and stores the waiting times in the storage unit 104. Here, each waiting time W_{m,t} is calculated as follows: “the number of visitors i who are queuing for the attraction m at the simulation time point t/processing capacity of the attraction m”. Note that the number of visitors i who are queuing for the attraction m at the simulation time point t is the number of visitors i who are in the state of “queuing” and whose positions are the “attraction m” at the simulation time point t.

Note that after calculating and storing the waiting times W_{m,t}, the simulation unit 103 returns to step S303. As a result, steps S303 to S306 are repeatedly executed until the simulation time point t becomes the simulation end time point T.

Step S307: The simulation unit 103 updates states of all visitors i to “left” and updates their positions to the “entrance”. This is because the simulation time point t is T and corresponds to the closing time of the theme park.

Through the above, waiting times W_{m,t} of respective attractions m at each simulation time point t are obtained as simulation results. These waiting times W_{m,t} are estimation results of congestion degrees of respective attractions m at each simulation time point t.

<Simulation Results>

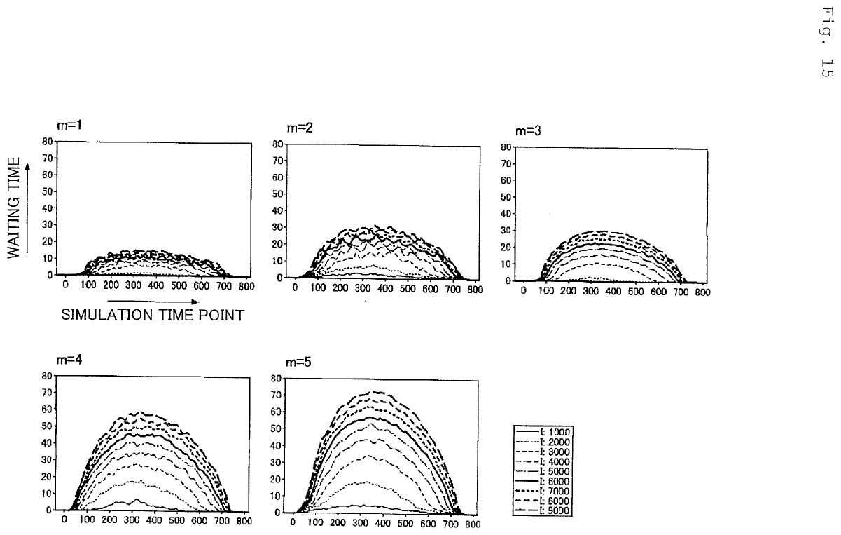

Next, simulation results (i.e., transition of waiting times W_{m,t} of attractions m at respective simulation time points t) in cases where M=5 and I=1000, 2000, 3000, 4000, 5000, 6000, 7000, 8000, or 9000 are shown in FIG. 15. Note that the waiting times of m=1 to m=5 shown in FIG. 15 are each an average value of waiting times W_{m,t} obtained by performing simulation 10 times while changing the seed of random numbers used to generate patience φᵢ and attraction preference vectors ψᵢ in steps S202 and S203 shown in FIG. 5.

As shown in FIG. 15, waiting times of all attractions m increased as the number I of visitors increased. These results show that congestion degrees (waiting times) of attractions in an actual theme park could be well reproduced and the congestion degrees could be estimated with high accuracy according to the embodiment of the present invention.

Therefore, according to the embodiment of the present invention, if acceptable limits α_{n,m} (n=1, . . . , N, m=1, . . . , M) are acquired in advance from some visitors using questionnaires or the like, it is possible to easily and accurately predict congestion degrees in a case where I (>N) people visit, while taking attraction preference of each visitor into consideration.

<Hardware Configuration of Congestion Degree Estimation Device 10>

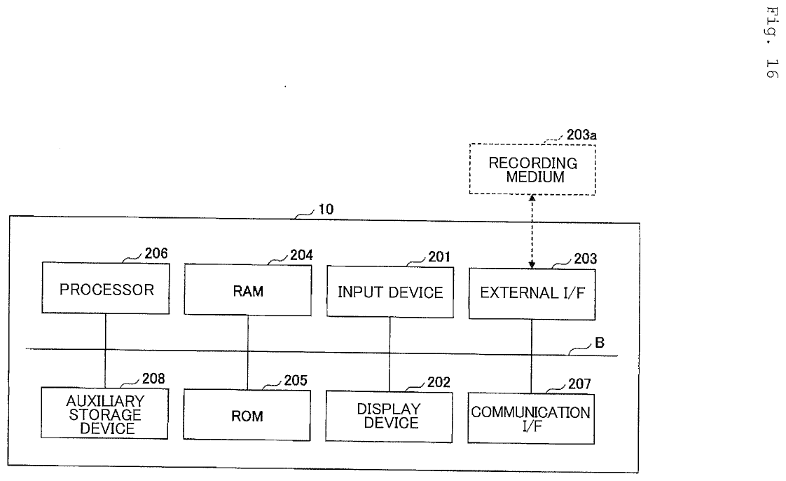

Lastly, a hardware configuration of the congestion degree estimation device 10 according to the embodiment of the present invention will be described with reference to FIG. 16. FIG. 16 is a diagram showing an example of the hardware configuration of the congestion degree estimation device 10 according to the embodiment of the present invention.

As shown in FIG. 16, the congestion degree estimation device. 10 according to the embodiment of the present invention includes an input device 201, a display device 202, an external I/F 203, a RAM (Random Access Memory) 204, a ROM (Read Only Memory) 205, a processor 206, a communication I/F 207, and an auxiliary storage device 208. These pieces of hardware are communicably connected to each other via a bus B.

The input device 201 is a keyboard, a mouse, a touch panel, or the like, and is used by a user to input various operations. The display device 202 is a display or the like, and displays results of processing performed by the congestion degree estimation device 10, for example. Note that a configuration is also possible in which the congestion degree estimation device 10 does not include either one or both of the input device 201 and the display device 202.

The external I/F 203 is an interface with an external device. Examples of the external device include a recording medium 203a. The congestion degree estimation device 10 can perform reading from and wiring into the recording medium 203a or the like via the external I/F 203. One or more programs for realizing the functional units (e.g., the parameter estimation unit 101, the visitor data creation unit 102, and the simulation unit 103) of the congestion degree estimation device 10 may be recorded on the recording medium 203a. Note that examples of the recording medium 203a include a CD (Compact Disc), a DVD (Digital Versatile Disk), an SD memory card, and a USB memory card.

The RAM 204 is a volatile semiconductor memory that temporarily stores programs and data. The ROM 205 is a non-volatile semiconductor memory that can hold programs and data even if power is turned off. Setting information regarding an OS (Operating System), setting information regarding a communication network, and the like are stored in the ROM 205, for example.

The processor 206 is a CPU (Central Processing Unit) or the like, and is an arithmetic device that reads programs and data from the ROM 205, the auxiliary storage device 208, and the like into the RAM 204 and executes various types of processing.

The communication I/F 207 is an interface for connecting the congestion degree estimation device 10 to a communication network. One or more programs for realizing the functional units of the congestion degree estimation device 10 may also be acquired (downloaded) from a predetermined server device or the like via the communication I/F 207.

The auxiliary storage device 208 is an HDD (Hard Disk Drive), an SSD (Solid State Drive), or the like, and is a non-volatile storage device in which programs and data are stored. Examples of the programs and data stored in the auxiliary storage device 208 include an OS, application programs for realizing various functions in the OS, and one or more programs for realizing the functional units of the congestion degree estimation device 10.

The present invention is not limited to the embodiment specifically disclosed above, and various variations and changes can be made without departing from the description of the claims.

### REFERENCE SIGNS LIST

10 Congestion degree estimation device
101 Parameter estimation unit
102 Visitor data creation unit
103 Simulation unit
104 Storage unit

1. A parameter estimation device comprising:
a memory; and
a processor coupled to the memory and configured to
in a case where a total number of N selection subjects n (n=1, . . . , N) each select any one of a total number of M selection targets m (m=1, . . . , M), input acceptable limits α_{n,m} of each selection subject n and calculate patience φₙ and a preference vector ψₙ, the acceptable limits α_{n,m} indicating limits of congestion degrees of respective selection subjects m that are acceptable to the selection subject n, the patience φₙ indicating the largest value of the acceptable limits α_{n,m} of the selection subject n with respect to the selection targets m, the preference vector ψₙ indicating preference of the selection subject n when selecting the selection targets m, and
estimate parameters of a model for obtaining acceptable limits α_{i,m} of each of a total number of I(>N) selection subjects i (i=1, . . . , I) by using the calculated patience φₙ and the calculated preference vector ψₙ.

2. The parameter estimation device according to claim 1, wherein the processor is further configured to
estimate, as parameters of the model, parameters μ and σ² of a normal distribution N(μ,σ²) that corresponds to a log-normal distribution, assuming that the patience φₙ follows the log-normal distribution, and
estimate, as a parameter of the model, a parameter β of a Dirichlet distribution Dir(β), assuming that the preference vector ψₙ follows the Dirichlet distribution Dir(β).

3. A congestion degree estimation device comprising:
a memory; and
a processor coupled to the memory and configured to:
in a case where a total number of N selection subjects n (n=1, . . . , N) each select any one of a total number of M selection targets m (m=1, . . . , M), input acceptable limits α_{n,m} of each selection subject n and calculate patience φₙ and a preference vector ψₙ, the acceptable limits α_{n,m} indicating limits of congestion degrees of respective selection subjects m that are acceptable to the selection subject n, the patience φₙ indicating the largest value of the acceptable limits α_{n,m} of the selection subject n with respect to the selection targets m, the preference vector ψₙ indicating preference of the selection subject n when selecting the selection targets m, and estimate parameters of a model for obtaining acceptable limits α_{i,m} of each of a total number of I(>N) selection subjects i (i=1, . . . , I) by using the calculated patience φₙ and the calculated preference vector ψₙ;
calculate the acceptable limits α_{i,m} of each selection subject i by using the model in which the estimated parameters are used; and
estimate congestion degrees of the respective selection targets m at each time point t (t=1, . . . , T) by inputting the acceptable limits α_{i,m} and simulation conditions and simulating selection of the selection targets m by the selection subjects i at each time point t.

4. The congestion degree estimation device according to claim 3, wherein the simulation conditions include information with which processing capacities of the respective selection targets m per unit time can be specified, and the processor is further configured to
calculate a probability θ_{i,m,t} of a selection subject i selecting a selection target m at a time point t (t=1, . . . , T), based on the acceptable limits α_{i,m} by using a polynomial linear model, and
estimate congestion degrees of the respective selection targets m at each time point t based on the calculated probability θ_{i,m,t} and the information with which processing capacities of the respective selection targets m per unit time can be specified.

5. The congestion degree estimation device according to claim 4, wherein the processor is further configured to
select, with respect to each selection subject i that is in a state of selecting any one of the selection targets m, a selection target m based on the probability θ_{i,m,t} from selection targets m for which W_{m,t}<α_{i,m} is satisfied, where W_{m,t} representing a congestion degree of a selection target m at a time point t, and
estimate a congestion degree of the selected selection target m based on the selected selection target m and information with which a processing capacity of the selected selection target m per unit time can be specified.

6. A parameter estimation method comprising
in a case where a total number of N selection subjects n (n=1, . . . , N) each select any one of a total number of M selection targets m (m=1, . . . , M), inputting acceptable limits α_{n,m} of each selection subject n and calculating patience φₙ and a preference vector ψₙ, the acceptable limits α_{n,m} indicating limits of congestion degrees of respective selection subjects m that are acceptable to the selection subject n, the patience φₙ indicating the largest value of the acceptable limits α_{n,m} of the selection subject n with respect to the selection targets m, the preference vector ψₙ indicating preference of the selection subject n when selecting the selection targets m, and
estimating parameters of a model for obtaining acceptable limits α_{i,m} of each of a total number of I(>N) selection subjects i (i=1, . . . , I) by using the calculated patience φₙ and the calculated preference vector ψₙ.

7. (canceled)

8. A non-transitory computer readable medium having a program embodied therein for causing a computer to perform the method of claim 6.
